(19) United States
(12) Patent Application Publication
(10) Pub. No.: US 2010/0211290 A1
(43) Pub. Date: Aug. 19, 2010

(54) ABNORMALITY DIAGNOSTIC DEVICE AND ABNORMALITY DIAGNOSTIC METHOD FOR MULTICYLINDER INTERNAL COMBUSTION ENGINE

(75) Inventors: Toru KIDOKORO, Hadano-shi (JP); Hiroshi SAWADA, Gotenba-shi (JP); Yasushi IWAZAKI, Ebina-shi (JP); Koichi KIMURA, Numazu-shi (JP); Hiroshi MIYAMOTO, Susono-shi (JP); Fumihiko NAKAMURA, Susono-shi (JP); Keiji IMAMURA, Susono-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/706,464

(22) Filed: Feb. 16, 2010

(30) Foreign Application Priority Data
Feb. 17, 2009 (JP) 2009-034207

(51) Int. Cl. F02D 41/30

(52) U.S. Cl. 701/103

(57) ABSTRACT

A fuel injection amount from fuel injection valves is actively controlled and an input air-fuel ratio is caused forcibly to oscillate. A system from the fuel injection valves to the air-fuel ratio sensor is simulated by a first order delay system, and a gain and time constant are identified on the basis of the input air-fuel ratio relating to the model and an output air-fuel ratio obtained from the air-fuel ratio sensor. The presence of an air-fuel ratio abnormal variation is diagnosed on the basis of whether or not the identified values of the gain and the time constant are less than a first and second predetermined values respectively.

### INCORPORATION BY REFERENCE

The disclosure of Japanese Patent Application No. 2009-034207 filed on Feb. 17, 2009 including the specification, drawings and abstract is incorporated herein by reference in its entirety.

### BACKGROUND OF THE INVENTION

1. Field of the Invention

The invention relates to an abnormality diagnostic device and an abnormality diagnostic method for a multicylinder internal combustion engine. More particularly, the invention relates to an abnormality diagnostic device and an abnormality diagnostic method for a multicylinder internal combustion engine that diagnose an air-fuel ratio abnormal variation among the cylinders.

2. Description of the Related Art

In an internal combustion engine provided with an exhaust gas purification system using a catalyst, a control of a mixing ratio of the air and fuel in a gas mixture that is burned in the internal combustion engine, that is, a control of the air-fuel ratio, is typically indispensable for conducting highly efficient purification of hazardous components from the exhaust gas. In order to conduct such a control of the air-fuel ratio, an air-fuel ratio sensor is provided in an exhaust gas passage of the internal combustion engine and a feedback control is implemented such that matches the air-fuel ratio detected by the sensor with a predetermined target air-fuel ratio.

In a multicylinder internal combustion engine, because the air-fuel ratio control is usually conducted using the same control amounts for all the cylinders, the actual air-fuel ratio can be varied among the cylinders even if the air-fuel ratio control is executed. Where the degree of variation in this case is small, it can be absorbed by the air-fuel ratio feedback control, and because the hazardous components in the exhaust gas can be purified with a catalyst, no adverse effect is produced on the exhaust gas emission and no significant problems are induced. However, for example, if a fuel injection system of some cylinders malfunctions and a significant variation occurs in the air-fuel ratio among the cylinders, the exhaust gas emission is degraded. It is preferred that the air-fuel ratio that is large enough to degrade the exhaust gas emission be detected as an abnormality. In particular, in the case of internal combustion engines for automobiles, it is required that the air-fuel ratio abnormal variation among the cylinders be detected in an onboard mode in order to prevent completely the vehicles with degraded exhaust gas emission from traveling. In recent years, a trend to regulating this by law has also been observed.

Japanese Patent Application Publication No. 2007-154840 (JP-A-2007-154840) discloses conducting the following air-fuel ratio control with the object of correcting the variation of air-fuel ratio among the cylinders. Thus, during normal operation, the fuel injection amount in an object cylinder is gradually decreased or increased and the fuel injection amount in other cylinders is accordingly increased or decreased to prevent the air-fuel ratio of the entire system from changing. In this process, the concentration of hydrogen in the exhaust gas is detected by a hydrogen sensor and the injection ratio at the time the hydrogen concentration assumes a minimum value is stored as an optimum injection ratio. The fuel in each cylinder is thereafter injected at the optimum injection ratio.

There are presently no devices that can advantageously diagnose an air-fuel ratio abnormal variation among the cylinders, the device described in JP-A-2007-154840 being no exception.

### SUMMARY OF THE INVENTION

The invention provides an abnormality diagnostic device and an abnormality diagnostic method for a multicylinder internal combustion engine that can advantageously diagnose an air-fuel ratio abnormal variation among the cylinders.

An abnormality diagnostic device for a multicylinder internal combustion engine according to the first aspect of the invention includes: a fuel injection valve disposed in each cylinder; an air-fuel ratio sensor disposed in an exhaust gas passage of the internal combustion engine; an active air-fuel ratio control unit that actively executes an active air-fuel ratio control of controlling an amount of fuel injected from the fuel injection valves and forcibly causing oscillations of an input air-fuel ratio; an identification unit that identifies a gain and a time constant in a first order delay system on the basis of the input air-fuel ratio relating to a model that simulates, with the first order delay system, a system from the fuel injection valves to the air-fuel ratio sensor during the execution of the active air-fuel ratio control and an output air-fuel ratio detected by the air-fuel ratio sensor; and an air-fuel ratio abnormal variation diagnostic unit that diagnoses the presence of an air-fuel ratio abnormal variation among the cylinders on the basis of whether or not the identified value of the gain is less than a first predetermined value and whether or not the identified value of the time constant is less than a second predetermined value.

When the air-fuel sensor is in an abnormal state, an event in which the gain decreases (that is, output decreases) and the time constant decreases (that is, responsiveness increases) at the same time practically never occurs, and this is a specific phenomenon observed when an air-fuel abnormal variation occurs. Thus, this phenomenon is employed in the first aspect of the invention, and the presence of an air-fuel ratio abnormal variation among the cylinders is diagnosed on the basis of whether or not the identified value of the gain is less than the first predetermined value and whether or not the identified value of the time constant is less than the second predetermined value. The air-fuel ratio abnormal variation among the cylinders can thus be advantageously diagnosed.

The air-fuel ratio abnormal variation diagnostic unit may diagnose that the air-fuel ratio abnormal variation is present when the identified value of the gain is less than the predetermined value and the identified value of the time constant is less than the predetermined value.

The abnormality diagnostic device may further include a sensor abnormality diagnostic unit that diagnoses the presence of an abnormality of the air-fuel ratio sensor on the basis of the identified value of the gain and the identified value of the time constant when the air-fuel ratio abnormal variation has been diagnosed by the air-fuel ratio abnormal variation diagnostic unit to be absent.

As a result, the abnormality diagnostic of the air-fuel ratio sensor can be also executed in the same process.

The air-fuel ratio abnormal variation diagnostic unit may diagnose the presence of an air-fuel ratio abnormal variation among the cylinders on the basis of the identified value of the gain and the identified value of the time constant at a point of time in which a predetermined time has elapsed since a start of the active air-fuel ratio control.

In this case, where the point of time in which a predetermined time has elapsed is a point of time in which the active air-fuel ratio control has ended a predetermined period or a point of time in which at least one of the identified value of the gain and the identified value of the time constant has converged.

The abnormality diagnostic device may further include an time delay detection unit that detects an actual time delay from the input air-fuel ratio to the output air-fuel ratio; and an time delay abnormality detection unit that diagnose the presence of an time delay abnormality on the basis of the detected actual time delay.

As a result, the diagnostic of the presence of an time delay abnormality caused by erroneous installation of the air-fuel ratio sensor can be executed in the same process.

According to the first aspect of the invention, the air-fuel ratio abnormality among the cylinders can be advantageously diagnosed.

The second aspect of the invention relates to an abnormality diagnostic method for a multicylinder internal combustion engine, wherein the multicylinder internal combustion engine includes a fuel injection valve disposed in each cylinder and an air-fuel ratio sensor disposed in an exhaust gas passage of the internal combustion engine. The abnormality diagnostic method includes: executing an active air-fuel ratio control of actively controlling an amount of fuel injected from the fuel injection valves and forcibly causing oscillations of an input air-fuel ratio; identifying a gain and a time constant in a first order delay system on the basis of the input air-fuel ratio relating to a model that simulates, with the first order delay system, a system from the fuel injection valves to the air-fuel ratio sensor during the execution of the active air-fuel ratio control and an output air-fuel ratio detected by the air-fuel ratio sensor; and diagnosing the presence of an air-fuel ratio abnormal variation among the cylinders on the basis of whether or not the identified value of the gain is less than a first predetermined value and whether or not the identified value of the time constant is less than a second predetermined value.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic drawing of an internal combustion engine of an embodiment of the invention;

FIG. 2 is a graph illustrating an output characteristic of a sensor before a catalyst;

FIG. 3 is a graph illustrating an output characteristic of the sensor after the catalyst;

FIG. 4 illustrates schematically how an input air-fuel ratio and an output air-fuel ratio change during the active air-fuel ratio control;

FIG. 5 is a schematic diagram of an identification logic of the embodiment;

FIG. 6 is a graph illustrating the results obtained in identifying the gain and time constant;

FIG. 7 is a graph illustrating an input air-fuel ratio before and after the time delay correction;

FIG. 8 shows a time delay calculation map;

FIG. 9 is a graph illustrating the results obtained in detecting the time delay in a case of a normal sensor;

FIG. 10 is a schematic partial enlarged view of the configuration shown in FIG. 9;

FIG. 11 is a graph illustrating the results obtained in detecting the time delay in a case of an abnormal sensor;

FIG. 12 is a schematic partial enlarged view of the configuration shown in FIG. 11;

FIG. 13 is a graph illustrating variations in a sensor output before the catalyst in a case where the air-fuel ratio abnormal variation is absent and in a case in which the abnormal variation is present;

FIG. 14 is a graph illustrating the relationship between the imbalance ratio and the identified value of the time constant and gain; and

FIG. 15 is a flowchart illustrating a routine of abnormality diagnostic processing.

### DETAILED DESCRIPTION OF EMBODIMENTS

An embodiment of the invention will be described below with reference to the appended drawings.

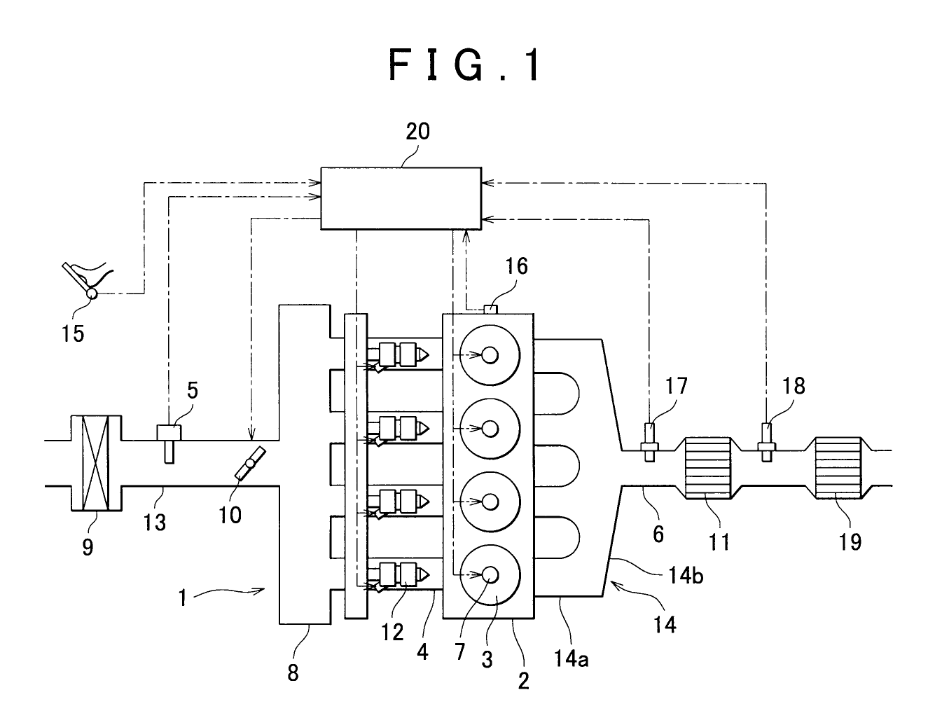

FIG. 1 is a schematic drawing of an internal combustion engine of an embodiment of the invention. As shown in the figure, in an internal combustion engine 1, a gaseous mixture of a fuel and air is burned inside a combustion chamber 3 formed in a cylinder block 2 and power is generated by causing a piston to perform a reciprocating movement inside the combustion chamber 3. The internal combustion engine 1 of the embodiment is a multicylinder internal combustion engine for an automobile, more specifically a parallel four-cylinder internal combustion engine of a spark ignition type, that is, a gasoline engine. However, an internal combustion engine to which the invention can be applied is not limited to the aforementioned engine, and the number of cylinders, system, and type of the engine are not particularly limited, provided that the engine is a multicylinder internal combustion engine.

Although not shown in the figure, an intake valve that opens and closes an intake port and an exhaust valve that opens and closes an exhaust port are installed in each cylinder in the cylinder head of the internal combustion engine 1. The intake valves and exhaust valves are opened and closed by a camshaft. A spark plug 7 that produces a spark in the gas mixture inside the combustion chamber 3 is attached for each cylinder to the top portion of the cylinder head.

The intake port of each cylinder is connected to a surge tank 8 that is an intake collection chamber via a branch pipe 4 provided for each cylinder. An intake pipe 13 is connected upstream of the surge tank 8. An air cleaner 9 is provided at the upstream end of the intake pipe 13. An air flowmeter 5 that detects the intake air quantity and an electronically controlled throttle valve 10 are incorporated in the intake pipe 13 in the order of description from the upstream side. An intake passage is formed by the intake port, branch pipe 4, surge tank 8, and intake pipe 13.

An injector (fuel injection valve) 12 that injects fuel is provided in the intake passage, in particular the intake port, for each cylinder. The fuel injected from the injector 12 is mixed with the intake air, thereby forming a gas mixture, the gas mixture is sucked into the combustion chamber 3 when the intake valve is opened, compressed by the piston, ignited by the spark plug 7 and burned.

The exhaust port of each cylinder is connected to the exhaust manifold 14. The exhaust manifold 14 is composed of a branch pipe 14a for each cylinder that forms an upstream portion of the exhaust manifold and an exhaust gas collection portion 14b that forms a downstream portion of the exhaust manifold. An exhaust pipe 6 is connected to the upstream side of the exhaust gas collection portion 14b. An exhaust passage is formed by the exhaust port, exhaust manifold 14, and exhaust pipe 6. Catalysts composed of respective three-way catalysts, that is, an upstream catalyst 11 and a downstream catalyst 19, are installed in serial on the upstream side and downstream side of the exhaust pipe 6. First and second air-fuel ratio sensors, that is, a before-catalyst sensor 17 and an after-catalyst sensor 18, that serve for detecting the air-fuel ratio of the exhaust gas are disposed on the upstream side and downstream side, respectively, of the upstream catalyst 11. These before-catalyst sensor 17 and after-catalyst sensor 18 are disposed in the exhaust passage in positions immediately before and immediately after the upstream catalyst 11 and detect the air-fuel ratio on the basis of oxygen concentration in the exhaust gas.

The aforementioned spark plug 7, throttle valve 10, and injector 12 are electrically connected to an electronic control unit (referred to hereinbelow as ECU) 20 as a control means. The ECU 20 includes a central processing unit (CPU), a read-only memory (ROM), a random access memory (RAM), an input/output port, and a storage device (not shown in the figures). Further, as shown in the figure, the aforementioned air flowmeter 5, before-catalyst sensor 17, after-catalyst sensor 18, and also a crank angle sensor 16 that detects a crank angle in the internal combustion engine 1, an accelerator depression amount sensor 15 that detects an accelerator depression amount, and other sensors are electrically connected via an analog/digital (A/D) converter (not shown in the figure) or the like to the ECU 20. The ECU 20 controls the spark plug 7, throttle valve 10, and injector 12 so as to obtain the desired outputs and also controls the ignition timing, fuel injection amount, fuel injection timing, and throttle opening degree on the basis of the detected values of the sensors. The throttle opening degree is usually controlled to a value corresponding to the accelerator depression amount.

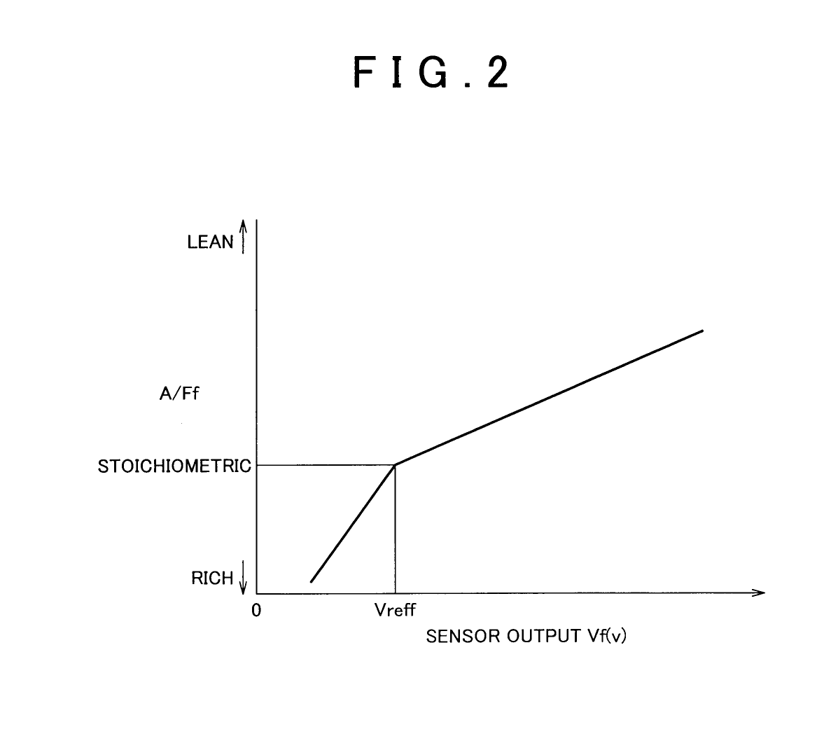

The before-catalyst sensor 17 is composed of the so-called wide-range air-fuel ratio sensor and can continuously detect the air-fuel ratio over a comparatively wide range. FIG. 2 shows an output characteristic of the before-catalyst sensor 17. As shown in FIG. 2, the before-catalyst sensor 17 outputs a voltage signal Vf of a value proportional to the detected exhaust air-fuel ratio (before-catalyst air-fuel ratio A/Ff). The output voltage at the time the exhaust air-fuel ratio is a theoretic air-fuel ratio, that is, at the time of a stoichiometric ratio, is Vreff (for example, 3.3 V), and the inclination of the air-fuel ratio−voltage characteristic changes at the stoichiometric ratio as a boundary.

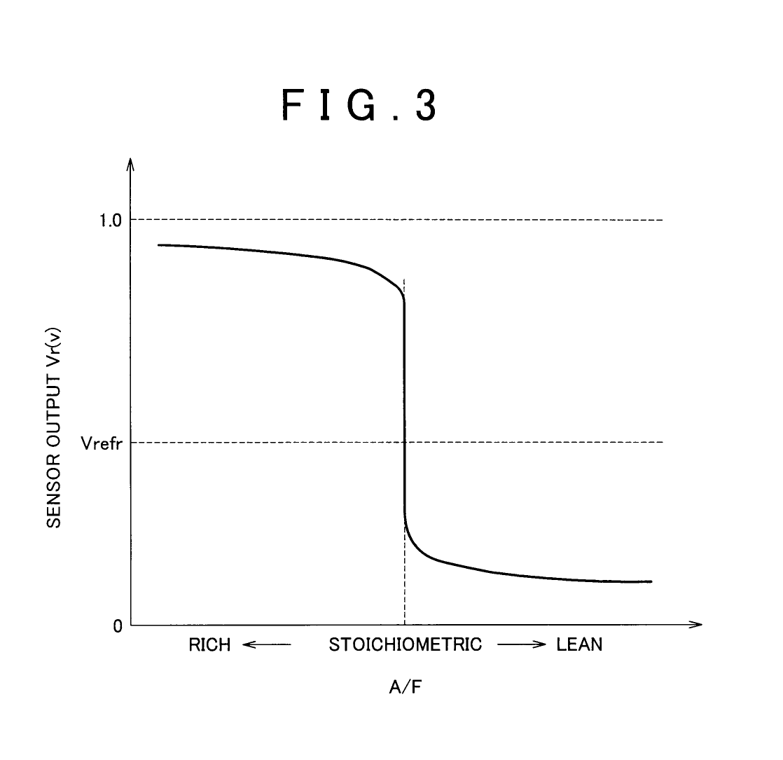

The after-catalyst sensor 18 is the so-called oxygen (O₂) sensor and has a characteristic in which the output value changes abruptly at the stoichiometric ratio as a boundary. FIG. 3 shows an output characteristic of the after-catalyst sensor 18. As shown in FIG. 3, the output voltage Vr of the after-catalyst sensor 18 shows a transient change at the stoichiometric ratio as a boundary. When the exhaust air-fuel ratio (after-catalyst air-fuel ratio A/Fr) is on the lean side of the stoichiometric ratio, a low voltage of about 0.1 V is outputted, and when the exhaust air-fuel ratio is on the rich side of the stoichiometric ratio, a high voltage of about 0.9 V is outputted. An intermediate voltage Vrefr=0.45 V is a value corresponding to the stoichiometric ratio, and the exhaust air-fuel ratio is detected so that when the sensor output voltage is higher than Vrefr, the exhaust air-fuel ratio is on the rich side of the stoichiometric ratio, and when the sensor output voltage is lower than Vrefr, the exhaust air-fuel ratio is on the lean side of the stoichiometric ratio.

The upstream catalyst 11 and downstream catalyst 19 simultaneously purify nitrogen oxide (NOx), hydrocarbon (HC), and carbon monoxide (CO), which are hazardous components contained in the exhaust gas, when the air-fuel ratio A/F of the inflowing exhaust gas is close to a theoretic air-fuel (A/F) ratio (stoichiometric ratio; for example, A/F=14.6). A width (window) of the air-fuel ratio in which these three components can be purified with high efficiency at the same time is comparatively narrow.

During normal operation of the engine, the fuel injection amount and then the air-fuel ratio of the gas mixture are controlled by the ECU 20 so that the air-fuel ratio of the exhaust gas flowing into the upstream catalyst 11 is controlled to a vicinity of the stoichiometric ratio. This air-fuel ratio control includes a main air-fuel ratio control (main air-fuel ratio feedback control) by which the exhaust air-fuel ratio detected by the before-catalyst sensor 17 is made equal to the stoichiometric ratio as a target air-fuel ratio and an auxiliary air-fuel ratio control (auxiliary air-fuel ratio feedback control) by which the exhaust air-fuel ratio detected by the after-catalyst sensor 18 is made equal to the stoichiometric ratio.

The diagnostic of air-fuel ratio abnormal variation among the cylinders in the embodiment will be explained below.

[Identification of Model Parameters and Time Delay Correction] In the abnormality diagnostic, the system from the injectors 12 to the before-catalyst sensor 17 is simulated by a first order delay system, and a gain k and a time constant T, which are parameters in the first order delay system, are identified (estimated) on the basis of the input air-fuel ratio relating to the model and the output air-fuel ratio detected by the before-catalyst sensor 17.

A ratio Ga/Q of the intake air quantity Ga calculated on the basis of the output of the air flowmeter 5 and a fuel injection amount Q calculated on the basis of the conduction time of the injector 12 is used as the input air-fuel ratio. The air-fuel ratio can be also referred to hereinbelow as an appropriate input and is represented by u(t) (u(t)=Ga/Q). The input air-fuel ratio can be called a calculated A/F. A before-catalyst air-fuel ratio A/Ff that is calculated from the output voltage Vr of the before-catalyst sensor 17 is used as the output air-fuel ratio. The output air-fuel ratio can be also referred to hereinbelow as an appropriate output and is represented by y(t)(y(t)=A/Ff). The parameters in the first order delay system are identified from the output of the output air-fuel ratio y(t) at the time the input air-fuel ratio u(t) is substituted into the model.

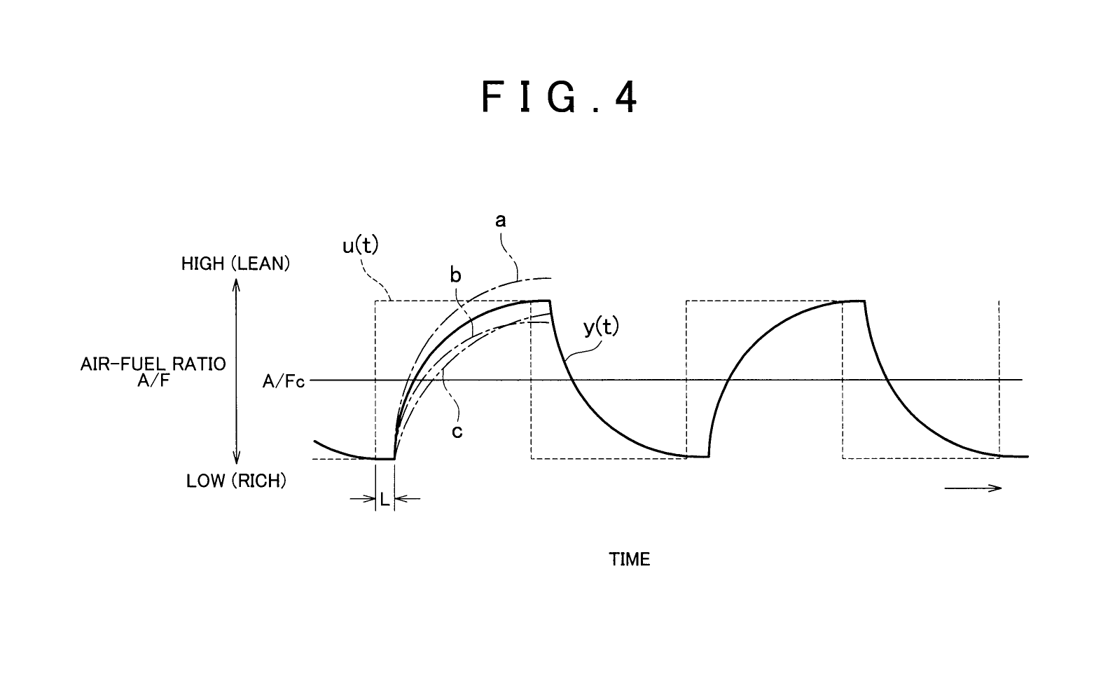

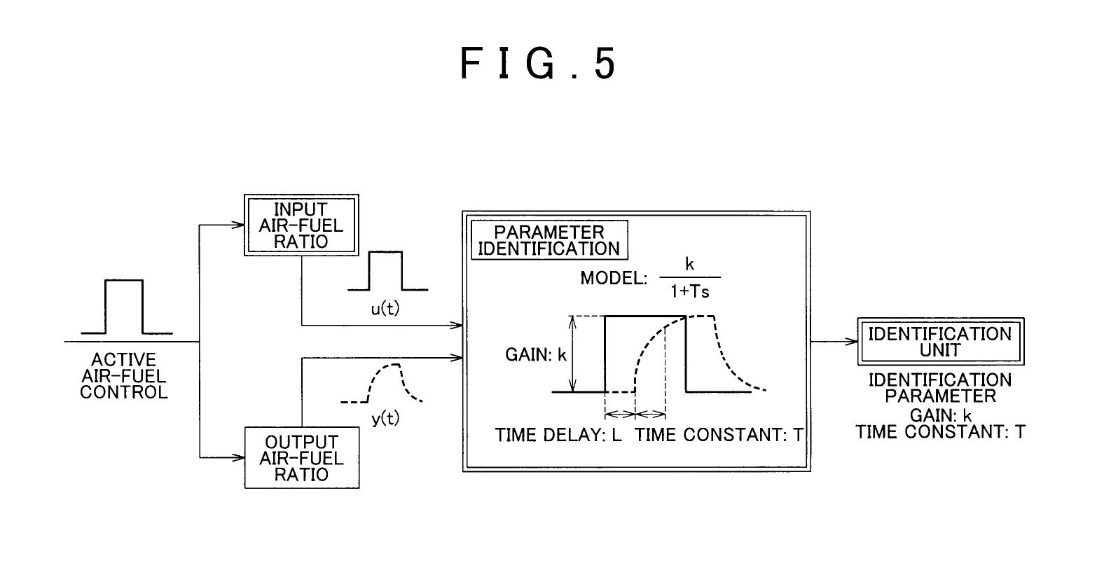

As shown in FIG. 4, in the embodiment, when the parameters are identified, an active air-fuel ratio control is executed by which the amount of fuel injected from the injector 12 is actively controlled and the input air-fuel ratio is caused to oscillate forcibly. In such active air-fuel ratio control, the target air-fuel ratio A/Ft, that is, the input air-fuel ratio u(t), is caused to oscillate with a constant period so as to oscillate with the same amplitude to the lean side and rich side, with a predetermined central air-fuel ratio A/Fc as a boundary. The amplitude of the oscillations is greater than that during the usual air-fuel ratio control. In the embodiment, the amplitude is 0.5, and the central air-fuel ratio A/Fc is equal to the theoretic air-fuel ratio (=14.6).

The active air-fuel ratio control is executed during normal operation of the engine. As a result, the control parameters and detected values are stabilized and the diagnostic accuracy is increased. Further, as described above, when the input air-fuel ratio u(t) is changed significantly in the active air-fuel ratio control, the parameter identification accuracy rises.

As shown in FIG. 4, the input air-fuel ratio u(t) has an almost step-like waveform. By contrast, the output air-fuel ratio y(t) has a waveform that follows a first order delay. In FIG. 4, L is a time delay based on a transfer delay from the input air-fuel ratio u(t) to the output air-fuel ratio y(t). The time delay L corresponds to a time difference from a fuel injection time in the injector 12 to the time at which the exhaust gas resulting from this fuel injection reaches the before-catalyst sensor 17.

Where the time delay L is assumed to be zero for the sake of simplification, the first order delay system will be represented by G(s)=k/(1+Ts). Here, k is the gain of the before-catalyst sensor 17 and T is the time constant of the before-catalyst sensor 17. The gain k is a value relating to the output from among the characteristics of the before-catalyst sensor 17. By contrast, the time constant T is a value relating to responsiveness from among the characteristics of the before-catalyst sensor 17.

A solid line representing the output air-fuel ratio y(t) in FIG. 4 indicates a case in which the before-catalyst sensor 17 is normal. By contrast, where an abnormality occurs in the output characteristic of the before-catalyst sensor 17, the gain k becomes larger than that in the normal state and the sensor output is increased (enlarged), as shown by “a”, or the gain k becomes less than that in the normal state and the sensor output is decreased (reduced), as shown by “b”. Where an abnormality occurs in the responsiveness of the before-catalyst sensor 17, the time constant T almost always becomes larger than that in the normal state and the sensor output is produced with a delay, as shown by “c”.

A method for identifying these gain k and time constant T that is executed by the ECU 20 will be explained below. This identification method uses an successive least squares technique.

Firstly, a transfer function of a first order delay system that has a time constant T and a gain k is represented as follows.

$$G ( s ) = \frac{k}{1 + T \times s} \qquad ( 1 )$$

A bilinear transformation s→z (continuous→discrete transformation)

$$s = \frac{2 ( 1 - {z}^{- 1} )}{Δ ( 1 + {z}^{- 1} )} \\ ( Δ : sampling interval ) \qquad ( 2 )$$

is applied to the foregoing equation (is substituted for s therein) to give

$$\begin{matrix}G ( z ) = \frac{Δ \times k \times {z}^{- 1} + Δ \times k}{( Δ - 2 T ) \times {z}^{- 1} + ( Δ + 2 T )} = \frac{{z}^{- 1} + 1}{{b}_{2} {z}^{- 1} + {b}_{1}} & ( 3 ) \\ ( ∵ {b}_{1} = \frac{Δ - 2 T}{Δ \times k} , {b}_{2} = \frac{Δ + 2 T}{Δ \times k} & ( 4 ) )\end{matrix}$$

The equations (4) are solved with respect to T and k to give

$$T = \frac{{b}_{1} - {b}_{2}}{{b}_{1} + {b}_{2}} \times \frac{Δ}{2} , k = \frac{2}{{b}_{1} + {b}_{2}} \qquad ( 5 )$$

Thus, if unknown parameters b₁, b₂ are found, the time constant T and the gain k of the sensor can be found from the equation (5).
Now, if the measured input and output are represented as ū(t), y̅(t), respectively, and the corresponding z transformations are represented as Ū(z), Y̅(z), respectively, the following equation is obtained from the equation (3).

$$\begin{matrix}\overline{Y} ( z ) = G ( z ) \times \overline{U} ( z ) \\ = \frac{{z}^{- 1} + 1}{{b}_{2} {z}^{- 1} + {b}_{1}} \times \overline{U} ( z ) \to {b}_{2} \overline{Y} ( z ) {z}^{- 1} + {b}_{1} \overline{Y} ( z ) \\ = \overline{U} ( z ) {z}^{- 1} + \overline{U} ( z )\end{matrix} \qquad ( 6 )$$

Besides, if the equation (6) is subjected to the inverse z transformation, the following equation is obtained.

b₂ y̅(t−1)+b₁ y̅(t)=ū(t−1)+ū(t) (7)

If this equation is reorganized in terms of sample times t, t−1, . . . , 1, the following equation is obtained.

$$[ \begin{matrix}\overline{u} ( t ) + \overline{u} ( t - 1 ) \\ \overline{u} ( t - 1 ) + \overline{u} ( t - 2 ) \\ ⋯ \\ \overline{u} ( 2 ) + \overline{u} ( 1 )\end{matrix} ] = [ \begin{matrix}\overline{y} ( t ) \\ \overline{y} ( t - 1 ) \\ \\ \overline{y} ( 2 )\end{matrix} \begin{matrix} \\ \\ ⋯ \\ \end{matrix} \begin{matrix}\overline{y} ( t - 1 ) \\ \overline{y} ( t - 2 ) \\ \\ \overline{y} ( 1 )\end{matrix} ] [ \begin{matrix}{b}_{1} \\ {b}_{2}\end{matrix} ] \qquad ( 8 )$$

With the following redefinition:

y(t)=ū(t)+ū(t+1)

φ(t)=[ y̅(t), y̅(t−1)]^{T} (9)

the equation (8) can be expressed as follows.

$$[ \begin{matrix}y ( t ) \\ y ( t - 1 ) \\ ⋯ \\ y ( 2 )\end{matrix} ] = [ \begin{matrix}{ϕ}^{T} ( t ) \\ {ϕ}^{T} ( t - 1 ) \\ ⋯ \\ {ϕ}^{T} ( 2 )\end{matrix} ] [ \begin{matrix}{b}_{1} \\ {b}_{2}\end{matrix} ] ⇒ y = F \times θ \qquad ( 10 )$$

Hence, the least square identification value of the identification parameter vector θ that includes the unknown parameters b₁, b₂ can be identified as in \hat{θ}=(F^{T}F)⁻¹×F^{T}×y. Furthermore, T and k can be found from the equation (5).

From the foregoing discussion, \hat{θ}(t) can be determined by calculating the inverse matrix (F^{T}F)⁻¹. However, considering the packaging into the ECU, the inverse matrix increases the amount of calculation, and is therefore not preferable. Therefore, recursive solution of the inverse matrix portion is conceivable. Firstly, given P(t)=(F^{T}F)⁻¹.

$$\begin{matrix}\hat{θ} ( t ) = P ( t ) {F}^{T} \times y \\ = P ( t ) \{ [ ϕ ( 1 ) , ϕ ( 2 ) , ⋯ϕ ( t ) ] [ \begin{matrix}y ( 1 ) \\ y ( 2 ) \\ ⋮ \\ y ( t )\end{matrix} ] \} \\ = P ( t ) {\sum }_{k = 1}^{t} ϕ ( k ) y ( k )\end{matrix} \qquad ( 11 )$$

From the equation (11),

$$\hat{θ} ( t - 1 ) = P ( t - 1 ) {\sum }_{k = 1}^{t - 1} ϕ ( k ) y ( k )$$

is also given. Therefore, the equation (11) can also be written as

$$\begin{matrix}\begin{matrix}\hat{θ} ( t ) = P ( t ) \{ {\sum }_{k = 1}^{t - 1} ϕ ( k ) y ( k ) + ϕ ( t ) y ( t ) \} \\ = P ( t ) \{ {P}^{- 1} ( t - 1 ) \times \hat{θ} ( t - 1 ) + ϕ ( t ) y ( t ) \} \end{matrix} \\ Besides , & ( 12 ) \\ \begin{matrix}P ( t ) = {( {F}^{T} F )}^{- 1} \\ = {\{ [ ϕ ( 1 ) , ϕ ( 2 ) , ⋯ , ϕ ( t ) ] [ \begin{matrix}{ϕ}^{T} ( 1 ) \\ {ϕ}^{T} ( 2 ) \\ ⋮ \\ {ϕ}^{T} ( t )\end{matrix} ] \}}^{- 1} \\ = {\{ {\sum }_{k = 1}^{t} ϕ ( k ) {ϕ}^{T} ( k ) \}}^{- 1}\end{matrix} & ( 13 )\end{matrix}$$

can be modified into

$$\begin{matrix}{P}^{- 1} ( t ) = {\sum }_{k = 1}^{t} ϕ ( k ) {ϕ}^{T} ( k ) \\ = {\sum }_{k = 1}^{t - 1} ϕ ( k ) {ϕ}^{T} ( k ) + ϕ ( t ) {ϕ}^{T} ( t ) \\ = {P}^{- 1} ( t - 1 ) + ϕ ( t ) {ϕ}^{T} ( t )\end{matrix} \qquad ( 14 )$$

If, using the equation (14), the term P⁻¹(t−1) in the equation (12) is eliminated, \hat{θ}(t) can be represented by the following recurrence formula.

\hat{θ}(t)=P(t){(P⁻¹(t)−φ(t)φ^{T}(t))×\hat{θ}(t−1)+φ(t)y(t)}=\hat{θ}(t−1)+P(t)φ(t)(y(t)−φ^{T}(t)×\hat{θ}(t−1)) (15)

Herein, if in the following theorem regarding the inverse matrix:

(A⁻¹+C^{T}B⁻¹D)⁻¹=A−AC^{T}(DAC^{T}+B)⁻¹DA (16)

replacements of A→P(t−1), C→φ^{T}(t), B→1, and D→φ^{T}(t) are made, the equation (14) can be expressed as follows:

{P⁻¹(t−1)+φ(t)φ^{T}(t)}⁻¹={P⁻¹(t)}⁻¹=P(t)=P(t−1)−P(t−1)φ(t){φ^{T}(t)P(t−1)φ(t)+1}⁻¹φ^{T}(t)×P(t−1) (17)

If the equation (17) is modified after the two sides thereof are multiplied by φ(t), P(t) can also be expressed in a manner of a recurrence formula as follows:

$$P ( t ) ϕ ( t ) = P ( t - 1 ) ϕ ( t ) \times \frac{1}{{ϕ}^{T} ( t ) P ( t - 1 ) ϕ ( t ) + 1} = K ( t ) \qquad ( 18 )$$

where φ^{T}(t)P(t−1)φ(t)+1 is a scalar.
The prediction error is defined as follows:

ε(t)=y(t)−φ^{T}(t)×\hat{θ}(t−1) (19)

By substituting the equations (18) and (19) in the equation (15), \hat{θ} is finally expressed by the following recurrence formula:

\hat{θ}(t)=\hat{θ}(t−1)+K(t)×ε(t) (20)

Thus, \hat{θ}=(F^{T}F)⁻¹F^{T}×y can be recursively solved.

Equation (20) represents a function of values at a present sampling time t and a previous sampling time t−1. This equation means that b₁ and b₂, that is, T and k, are each time updated on the basis of the present value and previous value. The time constant T and gain k are thus iteratively identified by the successive least squares technique. The successive least squares technique makes it possible to reduce the computation load and also reduce the capacity of a buffer that stores data temporarily with respect to those of a method by which a large number of sample data are acquired, temporarily stored, and then identified, and the successive least squares technique is advantageous for installation in the ECU (in particular, ECU for an automobile).

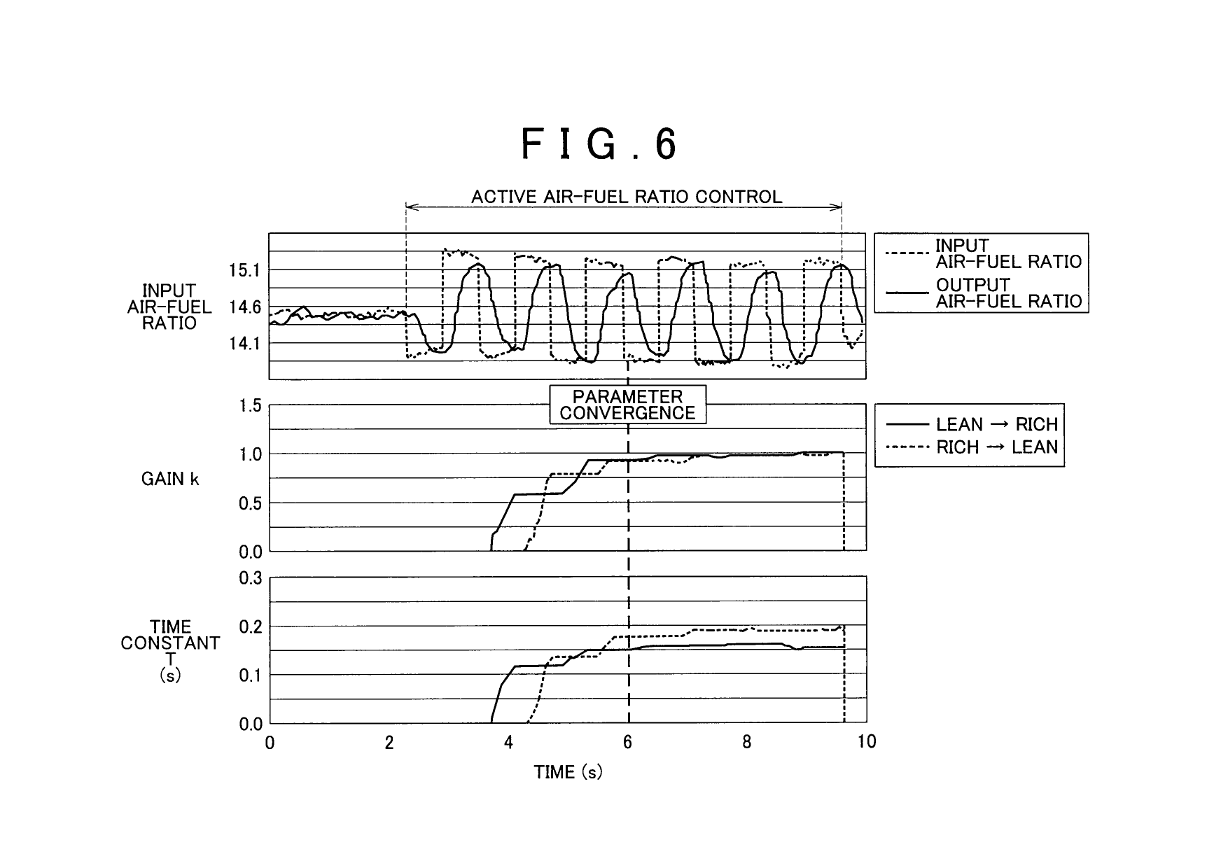

FIG. 6 shows the results obtained in iterative identification of the time constant T and gain k in a case of a normal before-catalyst sensor 17. Thus, the figure shows the input air-fuel ratio, output air-fuel ratio, gain k, and time constant T. The gain k and time constant T were separately identified with respect to a case of reversing the input air-fuel ratio from the lean side to the rich side and a case of reverting from the rich side to the lean side. In the first period of input air-fuel ratio oscillations, there is a residual effect of a state before the beginning of the active air-fuel ratio control. Therefore, no sampling is performed and this period is taken as the so-called waste peak. The sampling is started and identification is initiated from the second period of oscillations of the input air-fuel ratio. Referring to FIG. 6, the sampling and identification are ended at the end of the sixth period, and the identification is conducted by the data of five periods. The waste peak or frequency used for the identification can be set at your option. The gain k and time constant T are updated each time for each sample timing and successively converge to constant values. The identified value of the gain k and the identified value of the time constant T are then acquired at a point of time in which a predetermined time has elapsed since a start of the active air-fuel ratio control, and the acquired identified values are used for the air-fuel ratio abnormal variation diagnostic.

However, as described above, there is a time delay L caused by a transfer delay between the input air-fuel ratio u(t) and the output air-fuel ratio y(t). In order to conduct accurate identification of model parameters, it is preferred that a correction be performed to remove the time delay L. Accordingly, in the embodiment, the time delay correction is performed. More specifically, the time delay L is calculated by the below-described method, and the input air-fuel ratio u(t) is delayed to come close to the output air-fuel ratio y(t) by the calculated time delay L. Then, the above-described identification of the gain k and time constant T is executed by the input air-fuel ratio u(t) after the time delay correction and the output air-fuel ratio y(t).

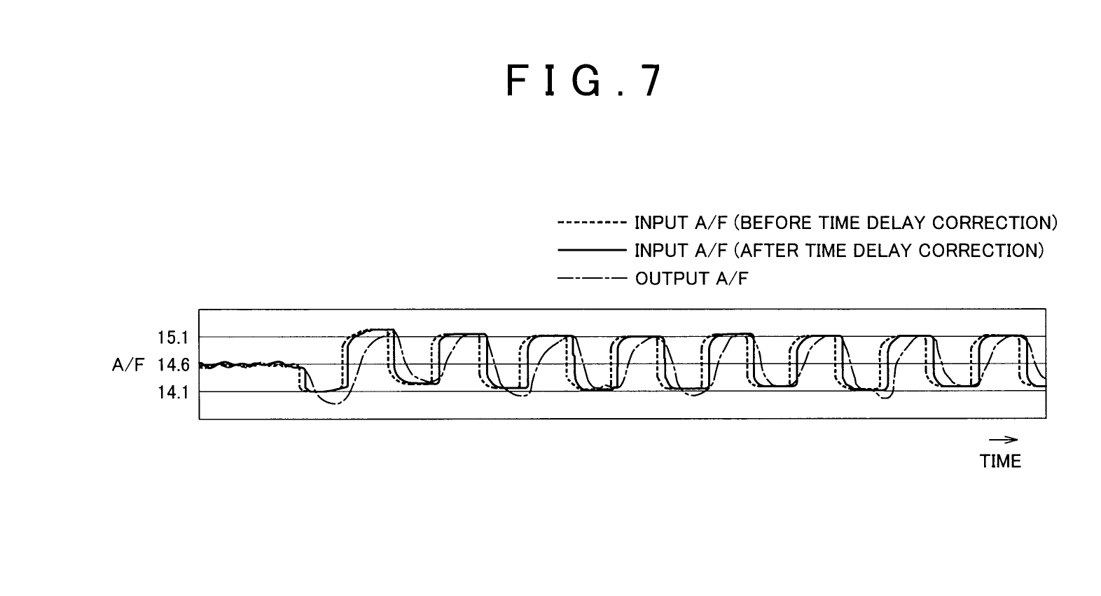

FIG. 7 shows the input air-fuel ratio before the time delay correction (broken line), input air-fuel ratio after the time delay correction (solid line), and output air-fuel ratio (dash-dot line). As clearly shown in FIG. 7, where the input air-fuel ratio is delayed by the time delay L, the oscillations of the input air-fuel ratio and the oscillations of the output are synchronized without any time difference therebetween. As a result, the identification accuracy of model parameters is increased.

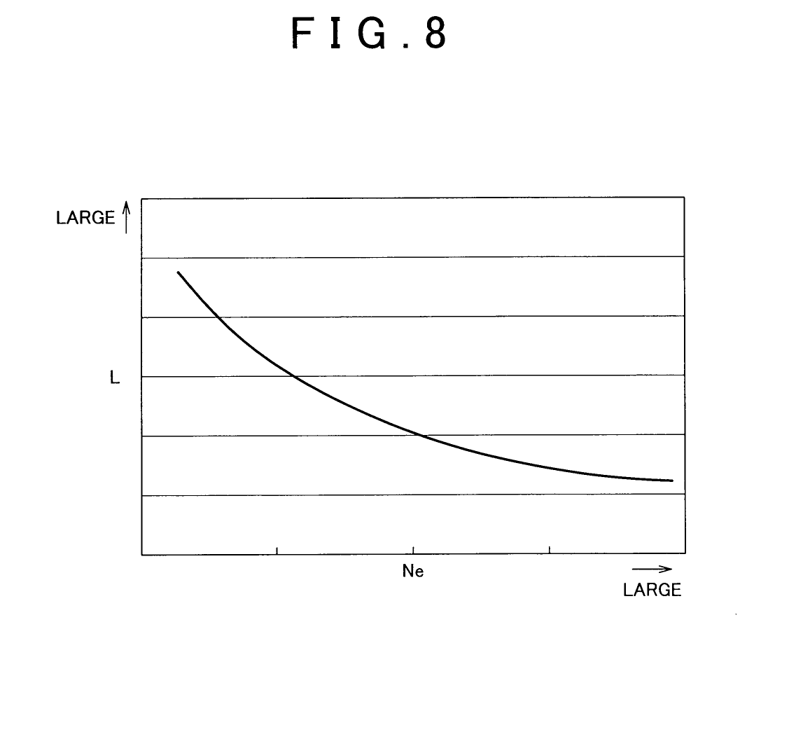

The time delay L is calculated according to a predetermined map or function on the basis of at least one parameter relating to the engine operation state. FIG. 8 shows an example of such a time delay calculation map. With the map, the time delay L is calculated on the basis of a detected value of engine revolution speed Ne. The input air-fuel ratio u(t) is corrected by using the time delay L thus calculated.

In the embodiment, the actual time delay L is detected by the below-descried method and map data are updated by the detected actual time delay L. First, a dispersion value a of the input air-fuel ratio and output air-fuel ratio in the active air-fuel ratio control is found iteratively by the following formula.

$$σ = \frac{1}{M} {\sum }_{j = 1}^{M} {\{ η ( t - j ) - {η}_{avg} ( t ) \}}^{2}$$

Here, η is a value of the input air-fuel ratio or output air-fuel ratio, η_{avg} is a moving average for M cycles, that is, an average value of data from the present cycle (t) to (t−(M−1)) before (M−1) cycles. M is taken, for example, as 5. The larger is the variation of the input air-fuel ratio or output air-fuel ratio, the larger is the dispersion value σ.

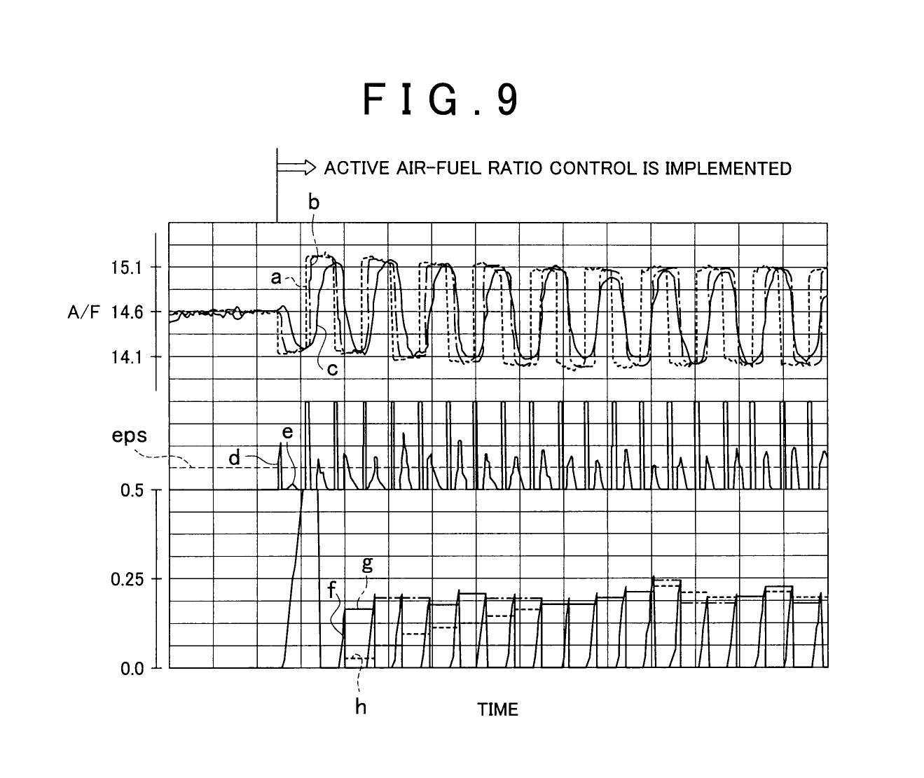

FIG. 9 shows the results obtained in detecting the time delay in a case of normal before-catalyst sensor 17 (referred to hereinbelow as “normal sensor”). In the upper graph, (a) is an input air-fuel ratio before the time delay correction, (b) is an input air-fuel ratio after the time delay correction, and (c) is an output air-fuel ratio. In the medium-stage graph, (d) is a dispersion value of the input air-fuel ratio before the time delay correction shown in (a), and (e) is a dispersion value of the output air-fuel ratio shown by (c). In the lower graph, the sawtooth waveform (f) shows the count of the time delay counter, and the transverse line (g) in a high position is the actual time delay that is calculated in the below described manner. The transverse line (h) in a low position is obtained by smoothing the time delay (g) at a ¼ ratio and shown for reference.

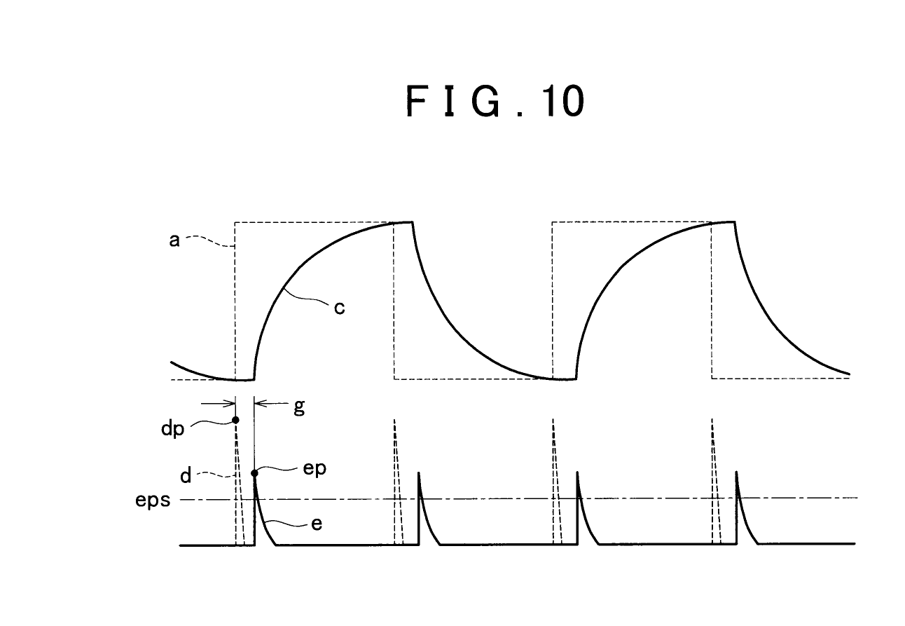

In FIG. 10, only (a), (c), (d), and (e) of FIG. 9 are shown in a simplified form. As follows from FIG. 10, in the dispersion value (d) of the input air-fuel ratio and the dispersion value (e) of the output air-fuel ratio, peaks dp, ep of the dispersion values (d), (e) appear at timings in which the input air-fuel ratio (a) and output air-fuel ratio (c) are reversed. Therefore, the time difference (ep−dp) of these peaks is taken as the actual time delay (g) that has to be detected.

Returning to FIG. 9, where the dispersion value peak dp of the input air-fuel ratio occurs, the count of time delay is started from this occurrence time. Then, in a point of time at which the dispersion value peak ep of the output air-fuel ratio occurs, the count is stopped and the respective count value is taken as the actual time delay (g). The actual time delay (g) is updated and stored each time the intake air-fuel ratio is reversed. The time delay (h) after smoothing is also computed for each inversion of the input air-fuel ratio. Where the inversion of the input air-fuel ratio is thus repeated, data on the time delay (g) that are equal in number to the repetitions are obtained. In the embodiment, the average value of the actual time delay (g) obtained at the identification end time and therebefore is computed, and this average value is taken as the actual time delay serving as a final detected value.

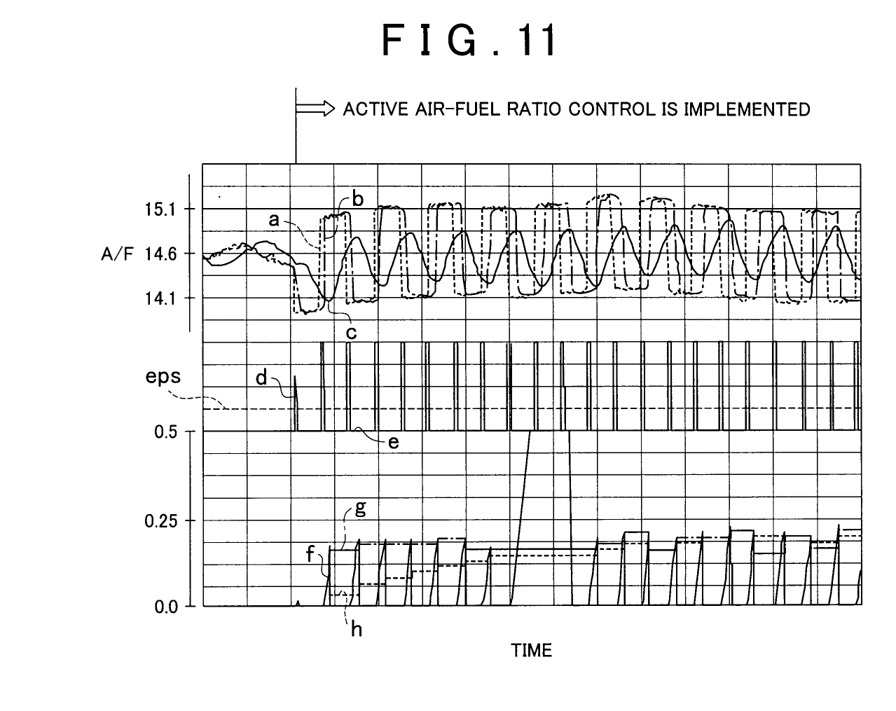

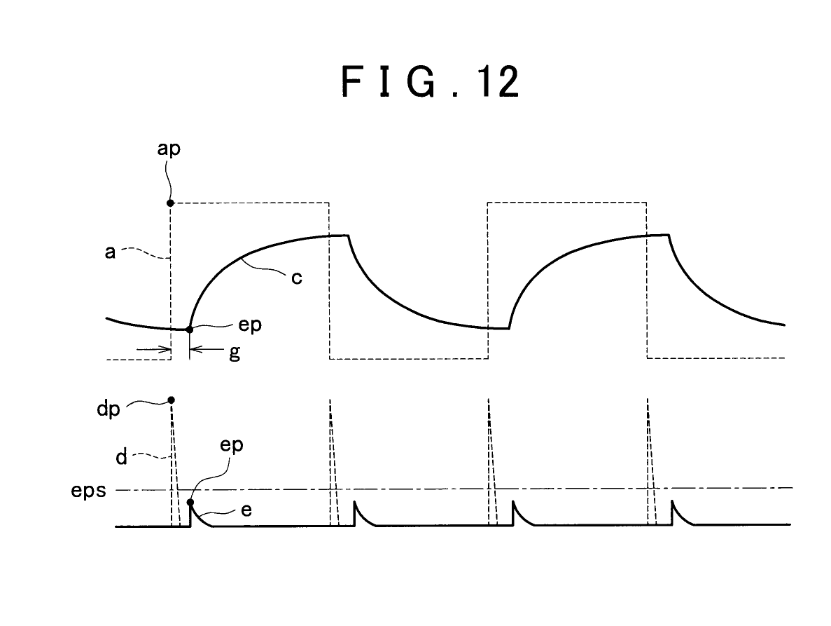

The method explained with reference to FIGS. 9 and 10 is applied in a case of normal before-catalyst sensor 17. In a case of abnormal before-catalyst sensor 17 (referred to hereinbelow as abnormal sensor), the application of a similar method is not necessarily adequate. Thus, as shown in FIGS. 11 and 12, for example, in a case of abnormal sensor in which a response delay has occurred, a sufficient dispersion value (e) of the output air-fuel ratio (b) cannot be obtained and an error relating to a timing at which the peak ep appears is increased.

Accordingly, when the dispersion peak ep of the output air-fuel ratio is compared with a predetermined threshold eps and the dispersion value peak ep is larger than the threshold eps, as shown in FIGS. 9 and 10, the actual time delay (g) that has to be detected is found by means of the time difference (ep−dp) between the dispersion value peaks dp, ep of the input and output air-fuel ratios. By contrast, in a case where the dispersion value peak ep of the output air-fuel ratio is equal to or less than the threshold value eps, as shown in FIGS. 11 and 12, the actual time delay (g) that has to be detected is found by means of the time difference (cp−ap) between the peak values ap, cp of the input and output air-fuel ratios (a) and (c). Thus, the time delay can be detected with good accuracy even in the case of abnormal sensor. In the same manner as described above, the average value of the actual time delay (g) obtained before the identification end point is taken as the actual time delay serving as a final detected value.

Where the final actual time delay is thus obtained, the map data of the time delay calculation map is updated based on the obtained value. As a result, an adequate time delay corresponding to the deterioration degree of the before-catalyst sensor 17 can be calculated and the accuracy of time delay correction is increased.

[Air-Fuel Ratio Abnormal Variation Diagnostic] For example, where a comparatively large shift or abnormal variation of the actual air-fuel ratio among the cylinders occurs due to a failed injector in one cylinder, the effect thereof is reflected in the output of the before-catalyst sensor 17, and the identified values of the gain k and time constant T are found to become inadequate even though the before-catalyst sensor 17 is normal.

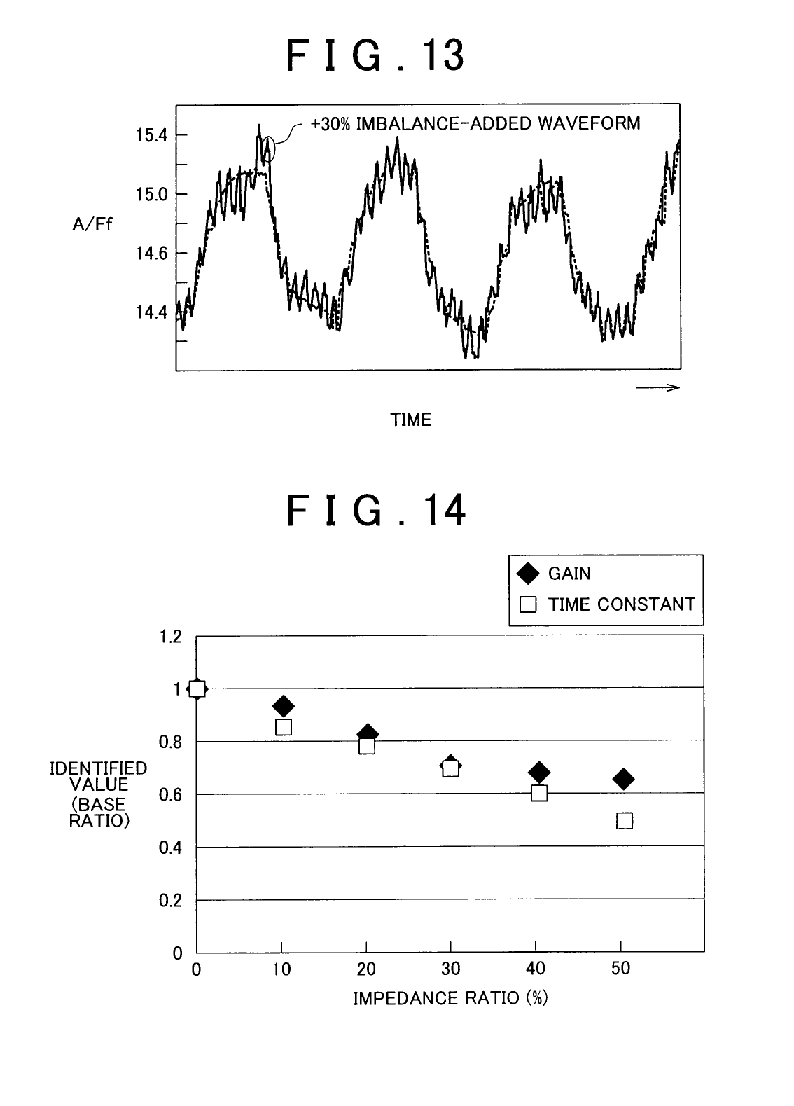

FIG. 13 shows the output values of the before-catalyst sensor 17 (calculated as the before-catalyst air-fuel ratio A/Ff) in a case where the air-fuel ratio abnormal variation is absent (dot line) and present (solid line). The waveform in a case the air-fuel ratio abnormal variation is present is a wavelength at the time the below-descried imbalance ratio is +30%. As shown in FIG. 13, where an air-fuel ratio abnormal variation occurs, a fluctuation of air-fuel ratio occurs within one engine cycle (crank angle=720°) and fluctuations of sensor output increase accordingly. At the same time, high-frequency fluctuations are superimposed on the waveform in a case where the air-fuel ratio abnormal variation is absent. Under the effect of these high-frequency fluctuations, the identified values of the time constant T and gain K that are finally obtained decrease with respect to the inherently obtained values.

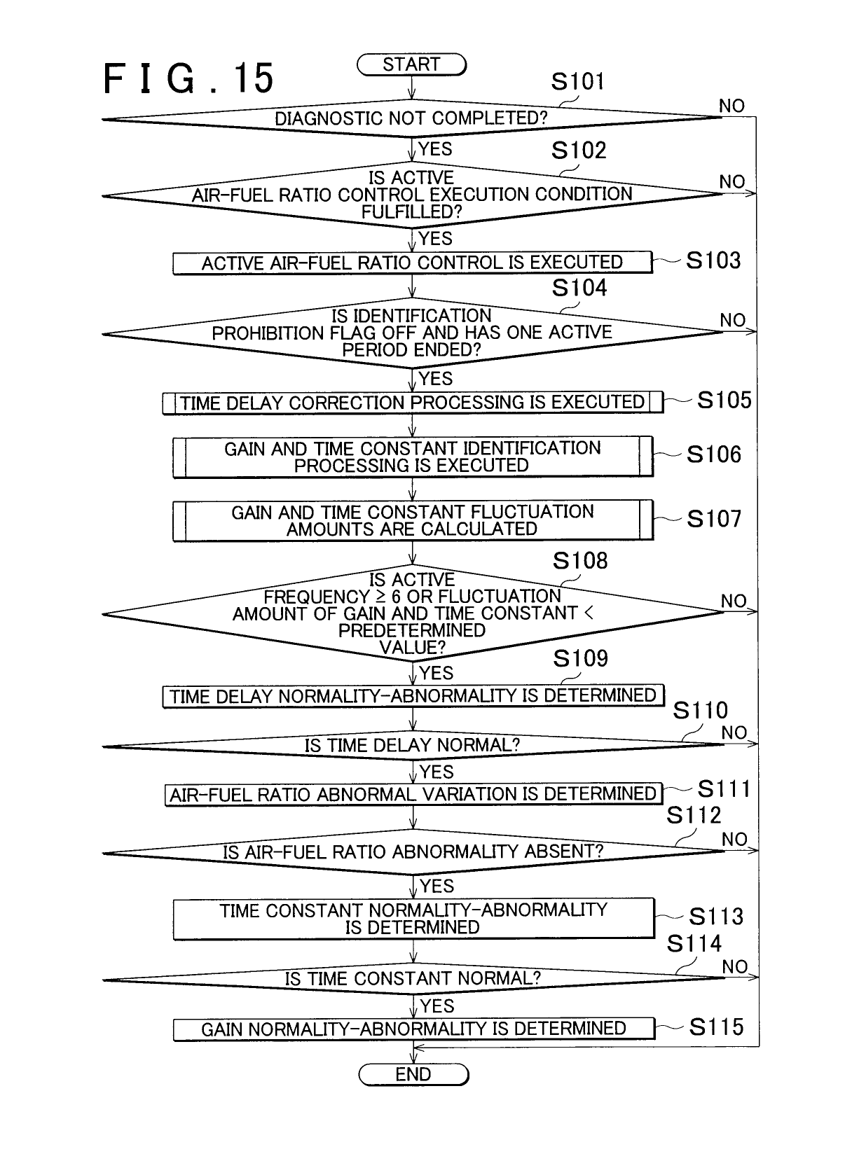

FIG. 14 shows the relationship between the air-fuel ratio abnormal variation and the identified values of the time constant T and gain k in a case of normal before-catalyst sensor 17. An imbalance ratio (%) as an imbalance parameter, which is a parameter relating to the abnormal variation (imbalance) of the air-fuel ratio among the cylinders, is plotted against the abscissa. When a fuel injection amount shift occurs only in one cylinder from among all the cylinders, the fuel injection amount in the cylinder (imbalance cylinder) in which the fuel injection amount has shifted shifts from the fuel injection amount of the cylinder (balance cylinder) in which no fuel injection amount shift has occurred, that is, a reference injection amount. The imbalance ratio is a value indicating the degree of this shift in the fuel injection amount between the cylinders. Where the imbalance ratio is denoted by IB, the fuel injection amount of the imbalance cylinder is denoted by Qib, and the fuel injection amount of the balance cylinder, that is, the reference injection amount, is denoted by Qs, then IB can be represented as (Qib−Qs)/Qs. The larger is the imbalance ratio, the larger is the fuel injection amount shift of the imbalance cylinder with respect to the balance cylinder and the larger is the air-fuel ratio abnormal variation.

Base ratios of identified values of the time constant T and gain k is plotted against the ordinate. Thus, a value at a time the imbalance ratio is 0% is taken as a base value, and values obtained by dividing the values of the time constant T and gain k that have been actually identified by the base value are the base ratios.

As shown in FIG. 14, the larger is the imbalance ratio, the smaller are the identified values of the time constant T and gain k.

When the before-catalyst sensor 17 is in an abnormal state due to deterioration or failure, an event in which the gain k decreases (that is, output decreases) and the time constant decreases (that is, responsiveness increases) at the same time practically never occurs, and this is a specific phenomenon observed when an air-fuel abnormal variation occurs. Usually, the gain k decreases and the time constant T increases (that is, responsiveness decreases) at the same time. Therefore, the decrease in both the time constant T and the gain k is a specific phenomenon observed when an air-fuel ratio abnormal variation has occurred.

Accordingly, this phenomenon is employed in the embodiment, and the presence of an air-fuel ratio abnormal variation among the cylinders is diagnosed on the basis of whether or not the identified value of the gain k is less than a predetermined value kib and whether or not the identified value of the time constant T is less than a predetermined value Tib. More specifically, the air-fuel ratio abnormal variation is diagnosed to be present when the identified value of the gain k is less than a predetermined value kib and the identified value of the time constant T is less than a predetermined value Tib. Otherwise, the air-fuel ratio abnormal variation is diagnosed to be absent. The air-fuel ratio abnormal variation diagnostic can thus be advantageously executed.

[Air-Fuel Ratio Sensor Abnormality Diagnostic] Further, in the embodiment, where the air-fuel ratio abnormal variation is diagnosed to be absent, the presence of an abnormality of the before-catalyst sensor 17, which is the air-fuel ratio sensor, is also diagnosed based on the identified values of the gain k and time constant T. As a result, the abnormality diagnostic of the before-catalyst sensor 17 is executed after the effect of the air-fuel ratio abnormal variation has been confirmed to be absent, and the accuracy and reliability of the abnormality diagnostic of the before-catalyst sensor 17 can be increased.

More specifically, when the identified value of the gain k is larger than a predetermined gain increase abnormality determination value ks1, the before-catalyst sensor 17 is diagnosed to have an output increase abnormality, and when the identified value of the gain k is less than a gain reduction abnormality determination value ks2 (<ks1), the before-catalyst sensor 17 is diagnosed to have an output decrease abnormality. When the identified value of the gain k is equal to or greater than the gain reduction abnormality determination value ks2 and equal to or less than the gain increase abnormality determination value ks1, the before-catalyst sensor 17 is diagnosed to be normal with respect to the output.

Further, when the identified value of the time constant T is greater than a time constant abnormality determination value Ts, a response delay occurs and the before-catalyst sensor 17 is diagnosed to have a response abnormality. When the identified value of the time constant T is equal to or less than a time constant abnormality determination value Ts, the before-catalyst sensor 17 is diagnosed to be normal with respect to the response.

Thus, abnormalities of two representative characteristics, namely, output and responsiveness, of the before-catalyst sensor 17 are diagnosed simultaneously and individually instead of simply diagnosing an abnormality of the before-catalyst sensor 17. A very strict and advantageous abnormality diagnostic of the air-fuel ratio sensor can thus be realized.

In addition, in the embodiment, the actual time delay L is detected. Therefore, the presence of time delay abnormality can be also diagnosed by using this detected value. This procedure will be described below.

[Abnormality Diagnostic Processing] FIG. 15 shows a routine of abnormality diagnostic processing of the embodiment. This routine is repeatedly executed for each predetermined sampling interval by the ECU 20.

First, in step S101, it is determined whether the diagnostic in the present trip is completed. The trip as referred to herein is one period from start to stop of the engine.

Where it is determined that the diagnostic has already been completed, the routine ends, and where the diagnostic is determined not to be completed, the processing flow advances to step S102.

In step S102, it is determined whether an execution condition necessary to execute the active air-fuel ratio control is fulfilled. The execution condition as referred to herein for example requires that all the following conditions be fulfilled: the engine warm-up has been completed (for example, the cooling water temperature is equal to or higher than 75° C.), the upstream catalyst 11, downstream catalyst 19, before-catalyst sensor 17, and after-catalyst sensor 18 are all active, and the engine is in the normal operation state (for example, the fluctuation width of the intake air quantity within a predetermined interval is equal to or less than a predetermined value).

Where the execution condition is not fulfilled, the routine ends, and where the execution condition is fulfilled, the processing flow advances to step S103 and the active air-fuel ratio control is executed.

Then, in step S104, it is determined whether an identification prohibition flag is OFF and whether the initial one period (active one period) of the active air-fuel ratio control has ended. The identification prohibition flag as referred to herein is a flag that is ON when a predetermined condition that does not agree with the performance of identification of the gain k and time constant T is fulfilled and OFF when the condition is not fulfilled. The predetermined condition as referred to herein is a condition indicating that only data such as the input-output air-fuel ratio are obtained that do not require the inhibition of the active air-fuel ratio control, but are not necessarily suitable for identification. For example, this condition includes a condition of the fluctuation width of the accelerator depression amount being equal to or more than a predetermined value within a predetermined period. Further, it may also include at least one of a condition according to which a fluctuation width of the intake air quantity within a predetermined time being equal to or greater than a predetermined value that is less than that according to the active air-fuel ratio control execution condition, a condition of the exhaust gas re-circulation (EGR) amount being equal to or greater than a predetermined value, and a condition of a purge flow rate being equal to or greater than a predetermined value.

Interrupting the active air-fuel ratio control and starting the active air-fuel ratio control from the very beginning after the active air-fuel ratio control execution condition has been satisfied and the active air-fuel ratio control has been started results in a loss of one opportunity for diagnostic that has been gained with much efforts. Accordingly, when the identification prohibition flag is ON, the identification is temporarily stopped without sampling the data such as the input-output air-fuel ratio (or destructing data after sampling), while the active air-fuel ratio control is being continued. Then, after the identification prohibition flag has become OFF, the sampling of data and identification are restarted. Such an approach can advantageously ensure the opportunity for diagnostic.

The very first period of the active air-fuel ratio control is the aforementioned waste peak. However, the waste peak can be randomly set to any period.

Where the determination result of step S104 is NO, the routine ends, and where the determination result is YES, the processing flow advances to step S105.

In step S105, the time delay correction of the input air-fuel ratio is executed by the above-described method.

Then, in step S106, the gain k and time constant T are identified on the basis of the input air-fuel ratio after the correction and the output air-fuel ratio.

Then, in step S107, the fluctuation amounts of the identified values of the gain k and time constant T are calculated. The fluctuation amount of the identified value of the gain k is, for example, composed of an absolute value of a difference between the identified present gain k(t) and the previous gain k(t−1) identified one sampling interval before. The same is true for the fluctuation amount of the identification value of the time constant T. However, other computational methods can be also used to find these fluctuation amounts.

Then, in step S108, it is determined whether the number of the active air-fuel ratio control periods that have already been completed (active periods) has reached the number that is equal to or greater than 6, or whether the fluctuation amounts of the identified values of the gain k and time constant T are less than corresponding predetermined values. This is done to determine the identification end timing. Thus, once the number of active periods reaches 6, it unconditionally becomes the end of identification, and the identified values at this point in time become the final identified values. Further, even before the number of active periods reaches 6, if the fluctuation amounts of the identified values of the gain k and time constant T are less than the corresponding predetermined values, the identified values of the gain k and time constant T are assumed to converge, the identification ends at this point in time, and the identified values at this point in time become final identified values. Where one of the gain k and time constant T converges, it is also possible that the other has converged. Therefore, the convergence of any one identified value may be determined.

Where the characteristics of the before-catalyst sensor 17 are close to those of a new product, the identified values tend to converge faster. Meanwhile, the maximum number of active periods (=6) has to be set to a delayed timing such that each identified value converges even in the case of an abnormal sensor. Accordingly, even if the maximum number of active periods is not expected in the case of a normal sensor, the below-described normal-abnormal determination can be executed. Therefore, if the identified values of the gain k and time constant T have converged, the identification is ended even before the maximum number of active periods is reached. As a result, the diagnostic time as a whole can be shortened and more opportunities for subsequent diagnostic can be ensured.

The maximum number of active periods at which the identification ends is not limited to 6 and can be set to any value.

Where the determination result of step S108 is NO, the routine ends. By contrast, where the determination result of step S108 is YES, the identification of the gain k and time constant T ends and the processing flow advances to step S109. At the identification end time, the value of the actual time delay L is acquired as a detected value at the same time and map data are obtained by using this value. As shown in FIG. 6, in a case where the gain k and time constant T are identified individually at the time of reversal to the rich side and the time of reversal to the lean side, the average value of the values obtained at the time of reversal to the rich side and the time of reversal to the lean side can be taken as the final identified value.

In step S109, the time delay normality-abnormality determination is conducted. Thus, when the detected actual time delay L is greater than a predetermined time delay increase abnormality determination value Ls1, the time delay is determined to increase abnormally, and when the detected actual time delay L is less than a predetermined time delay decrease abnormality determination value Ls2 (<Ls1), the time delay is determined to decrease abnormally. When the detected actual time delay L is equal to or greater than the time delay decrease abnormality determination value Ls2 and equal to or less than the time delay increase abnormality determination value Ls1, the time delay is determined to be normal.

An erroneous installation resulting in erroneous assembly position of the before-catalyst sensor 17 or some kind of abnormality upstream of the before-catalyst sensor 17 can be considered as a reason for such time delay abnormalities. Therefore, these abnormalities can be also diagnosed by diagnosing whether the time delay is normal or abnormal.

Then, in step S110, it is determined whether a normal time delay has been determined. Where the normal time delay has not been determined, the reliability of each identified value can be considered to be low. Therefore, the routine ends without diagnosing the air-fuel ratio abnormal variation and before-catalyst sensor abnormality.

By contrast, where the normal time delay has been determined, the air-fuel ratio abnormal variation diagnostic is conducted in step S111. Thus, as described hereinabove, where the identified value of the gain k is less than the predetermined value kib and the identified value of the time constant T is less than the predetermined value Tib, the air-fuel ratio abnormal variation is determined to be present, otherwise the air-fuel ratio abnormal variation is determined to be absent.

Then, in step S112, it is determined whether the air-fuel ratio abnormal variation has been determined to be absent. Where such a determination has not been made, that is, the air-fuel ratio abnormal variation has been determined to be present, the reliability of each identified value can be considered to be low. Therefore, the routine ends without determining whether the before-catalyst sensor 17 is normal or abnormal.

By contrast, where the air-fuel ratio abnormal variation has been determined to be absent, the abnormality diagnostic of the before-catalyst sensor 17 is conducted in step S113 and thereafter. In step S113, it is determined whether the time constant is normal or abnormal. Thus, the identified value of the time constant T is compared with a time constant abnormality determination value Ts, and when T>Ts, the time constant is determined to be abnormal, that is, the responsiveness is determined to be abnormal. By contrast, when T≦Ts, the time constant is determined to be normal, that is, the responsiveness is determined to be normal.

Then, in step S114, it is determined whether the time constant has been determined to be normal. Where such a determination has not been made, the before-catalyst sensor 17 is diagnosed as abnormal and the routine ends without determining whether the gain k is normal or abnormal.

Where the time constant has been determined to be normal, it is determined in step S115 whether the gain is normal or abnormal. Thus, the identified value of the gain k is compared with the gain increase abnormality determination value ks1 and gain decrease abnormality determination value ks2, and when k>ks1 or k<ks2, the gain is determined to be abnormal, that is, the output is determined to be abnormal. By contrast, where ks1≦k≦ks2, the gain is determined to be normal, that is, the output is determined to be normal. Accordingly, the routine ends.

An embodiment of the invention has been described above in detail, but a variety of other embodiments of the invention can be also considered. For example, the above-described internal combustion engine is of an intake port (intake passage) injection system, but the invention can be also applied to a direct injection engine or a dual injection engine in which the two injection systems are combined. In the embodiment, the wide-band air-fuel ratio sensor is used before the catalyst and the O₂ sensor is used after the catalyst, but it is also possible to use, for example, the wide-band air-fuel ratio sensor after the catalyst and the O₂ sensor before the catalyst. A sensor for detecting an air-fuel ratio of exhaust gas in a wide sense of the term, inclusive of these wide-band air-fuel ratio sensor and O₂ sensor, may be used as the air-fuel ratio sensor as referred to in accordance with the invention. The least squares method was used one after another in the embodiments, but other methods, for example, the Kalman filter method, can also be used.

The embodiments of the invention are not limited to the above-described embodiments, and various modifications, application examples, and equivalent arrangements that are included in the concept of the invention specified by the claims are covered by the invention. Therefore, the invention should not be construed to be limited to the above-described embodiments and can be applied to various other technologies within the scope of the invention.

What is claimed is:

1. An abnormality diagnostic device for a multicylinder internal combustion engine, comprising:
a fuel injection valve disposed in each cylinder;
an air-fuel ratio sensor disposed in an exhaust gas passage of the internal combustion engine;
an active air-fuel ratio control unit that actively executes an active air-fuel ratio control of controlling an amount of fuel injected from the fuel injection valves and forcibly causing oscillations of an input air-fuel ratio;
an identification unit that identifies a gain and a time constant in a first order delay system on the basis of the input air-fuel ratio relating to a model that simulates, with the first order delay system, a system from the fuel injection valves to the air-fuel ratio sensor during the execution of the active air-fuel ratio control and an output air-fuel ratio detected by the air-fuel ratio sensor; and
an air-fuel ratio abnormal variation diagnostic unit that diagnoses the presence of an air-fuel ratio abnormal variation among the cylinders on the basis of whether or not the identified value of the gain is less than a first predetermined value and whether or not the identified value of the time constant is less than a second predetermined value.

2. The abnormality diagnostic device according to claim 1, wherein the air-fuel ratio abnormal variation diagnostic unit diagnoses that the air-fuel ratio abnormal variation is present when the identified value of the gain is less than the first predetermined value and the identified value of the time constant is less than the second predetermined value.

3. The abnormality diagnostic device according to claim 1, further comprising:
a sensor abnormality diagnostic unit that diagnoses the presence of an abnormality of the air-fuel ratio sensor on the basis of the identified value of the gain and the identified value of the time constant when the air-fuel ratio abnormal variation has been diagnosed to be absent by the air-fuel ratio abnormal variation diagnostic unit.

4. The abnormality diagnostic device according to claim 1, wherein the air-fuel ratio abnormal variation diagnostic unit diagnoses the presence of an air-fuel ratio abnormal variation among the cylinders on the basis of the identified value of the gain and the identified value of the time constant at a point of time in which a predetermined time has elapsed since a start of the active air-fuel ratio control.

5. The abnormality diagnostic device according to claim 4, wherein the point of time in which a predetermined time has elapsed is a point of time in which the active air-fuel ratio control has ended a predetermined period or a point of time in which at least one of the identified value of the gain and the identified value of the time constant has converged.

6. The abnormality diagnostic device according to claim 1, further comprising:
a time delay detection unit that detects an actual time delay from the input air-fuel ratio to the output air-fuel ratio; and
a time delay abnormality detection unit that diagnoses the presence of an time delay abnormality on the basis of the detected actual time delay.

7. An abnormality diagnostic method for a multicylinder internal combustion engine, wherein the multicylinder internal combustion engine includes a fuel injection valve disposed in each cylinder and an air-fuel ratio sensor disposed in an exhaust gas passage of the internal combustion engine,
the abnormality diagnostic method comprising:
executing an active air-fuel ratio control of actively controlling an amount of fuel injected from the fuel injection valves and forcibly causing oscillations of an input air-fuel ratio;
identifying a gain and a time constant in a first order delay system on the basis of the input air-fuel ratio relating to a model that simulates, with the first order delay system, a system from the fuel injection valves to the air-fuel ratio sensor during the execution of the active air-fuel ratio control and an output air-fuel ratio detected by the air-fuel ratio sensor; and
diagnosing the presence of an air-fuel ratio abnormal variation among the cylinders on the basis of whether or not the identified value of the gain is less than a first predetermined value and whether or not the identified value of the time constant is less than a second predetermined value.
